(19) United States
(12) Patent Application Publication
(10) Pub. No.: US 2024/0036302 A1
(43) Pub. Date: Feb. 1, 2024

(54) NIGHT VISION BINOCULARS

(71) Applicant: THALES, Courbevoie (FR)

(72) Inventor: Gabriel NARCY, Saint Heand (FR)

(21) Appl. No.: 18/267,845

(22) PCT Filed: Dec. 17, 2021
(86) PCT No.: PCT/EP2021/086607

§ 371 Date: Jun. 16, 2023

(30) Foreign Application Priority Data
Dec. 18, 2020 (FR) FR2013655

(51) Int. Cl. G02B 23/12; G02B 7/12; G02B 27/14

(52) U.S. Cl. CPC G02B 23/12; G02B 7/12; G02B 27/144

(57) ABSTRACT

The present invention relates to night-vision binoculars, comprising:
a. a fixed lens assembly comprising a projection lens having an output axis referred to as the projection axis,
b. two eyepieces, each eyepiece having an output axis referred to as the vision axis, the vision axes of the two eyepieces being parallel and separated by an adjustable distance, called inter-pupillary distance, the vision axis of each eyepiece also being parallel to the projection axis of the lens assembly and having the same non-zero centre-to-centre distance from the projection axis of the lens assembly, each eyepiece being rotatably movable relative to the projection axis of the lens assembly so as to adjust the inter-pupillary distance.

This invention concerns night-vision binoculars.

More precisely, the invention concerns night-vision binoculars configured to capture and intensify images originating from a scene. The spectral domain of intensification is typically between 450 and 950 nm. When such binoculars are configured to project information originating from a screen on the intensified image, they are referred to as ‘connected’.

Connected night-vision binoculars comprising two capture paths, each associated with an eyepiece, are known from the prior art. However, only one of the two paths is associated with means of projection of information from a screen on the image captured. Thus, the information originating from the screen is only visible through one of the eyepieces, which is problematic when this eyepiece does not correspond to the dominant eye of the user.

This projection on only one of the two paths is explained by the technical and economic difficulties of providing a mechanism for adjusting the inter-pupillary distance (IPD) between the two eyepieces. In particular, in the night-vision binoculars available on the market, the IPD adjustment is either linear or rotary.

In the case of linear IPD adjustment, the two binocular bodies are guided mechanically by a slide link on a bracket. The bracket connects the two binocular bodies to the mechanical mount of the helmet or head harness. For unconnected night-vision binoculars (no screen), the power supply of the intensifier tube goes through flexible webs connecting the binocular bodies to the bracket or through electrical contacts on a track.

In the case of connected night-vision binoculars, the cables providing the power supply for the screen and the connection to video signals are added to those providing power to the intensifier tube, which makes the incorporation of such cables into the binocular body both technically and economically complex. The night-vision binoculars available on the market thus do not have an adjustable IPD and have a screen on a single path.

In the case of rotary IPD adjustment, the two binocular bodies are guided mechanically by a pivoting link on a bracket connecting the two binocular bodies to the mechanical support frame of the helmet or head harness. This type of IPD adjustment makes the passage of the cables easier than in the case of linear IPD adjustment solutions.

However, in the case of connected night-vision binoculars, this type of IPD adjustment induces rotation of the images from the screen. The images from the screen are thus perceived at an incline by the user. Solutions that incorporate a mechanical derotator are conceivable, but unsuitable from the microeconomic standpoint. Thus, for this reason, too, the night-vision binoculars available on the market do not have an adjustable IPD and have a screen on a single path.

There is thus a need for connected night-vision binoculars allowing for an intensified image of the scene comprising information from a screen to be visualized via both eyepieces, whilst also having an adjustable IPD.

To this end, this description concerns night-vision binoculars comprising:
a. one or two fixed lens assemblies, the/each lens assembly comprising:
i. a capture lens configured to capture an image of a scene,
ii. a light intensification device configured to intensify the image captured in order to obtain an intensified image,
iii. a screen suited to generate an additional image,
iv. a projection lens configured to project the additional image on the intensified image such that the output beam of the projection lens (‘projection beam’) transports the resultant image, wherein the projection lens has an output axis (‘projection axis’),
b. two eyepieces that receive either the same projection beam, when the binoculars comprise a single lens assembly, or different projection beams, when the binoculars comprise two lens assemblies,
wherein each eyepiece has an output axis (‘vision axis’), the vision axes of the two eyepieces being parallel and separated by an adjustable distance (‘inter-pupillary distance’),
wherein the vision axis of each eyepiece is further parallel to the projection axis of the corresponding lens assembly and has the same non-zero centre-to-centre distance as the projection axis of the corresponding lens assembly,
wherein each eyepiece is rotatable relative to the projection axis of the corresponding lens assembly so as to adjust the inter-pupillary distance.

In particular embodiments, the binoculars comprise one or more of the following characteristics, alone or in any combination technically possible:
the projection beam is a collimated or near collimated beam;
the vision axis of each eyepiece is the optical axis of the eyepiece;
the binoculars comprise two lens assemblies, the IPD being the sum of a nominal distance and an adjustment range, the value of the adjustment range being a function of the rotation of each eyepiece and being within a limited range centred on zero, the centre-to-centre distance between the vision axis of each eyepiece and the projection axis of the corresponding lens assembly being equal to one-half of the positive limit of the limited range;
each eyepiece has an input axis that coincides with the projection axis of the corresponding lens assembly, wherein the vision axis of each eyepiece is offset from the input axis of the eyepiece by a layover formed by two dioptres, each dioptre having a flat optical surface parallel to the flat optical surface of the other dioptre, wherein the first dioptre is configured to reflect at least part of the projection beam output by the corresponding lens assembly in the direction of the second dioptre, wherein the second dioptre is configured to reflect the projection beam in the direction of the vision axis;
the IPD is the sum of a nominal distance and an adjustment range that is a function of the rotation of each eyepiece, wherein the adjustment range is a function of the centre-to-centre distance between the projection axis and the vision axis of the eyepieces, a nominal orientation of the eyepieces, and a rotation angle of each eyepiece relative to the nominal orientation;
the binoculars comprise two lens assemblies;
the binoculars comprise a single lens assembly, such that the projection axis is the common rotation axis of the two eyepieces, wherein the flat optical surface of the first dioptre of one of the eyepieces (‘first eyepiece’) is partially reflective, so as to reflect part of the projection beam in the direction of the second dioptre of the first eyepiece and to transmit the other part in the direction of the other eyepiece (‘second eyepiece’);
the or each lens assembly comprises an input axis that is offset from the projection axis AP) of the corresponding projection lens by a layover formed by two dioptres, wherein each dioptre has a flat optical surface parallel to the flat optical surface of the other dioptre, wherein the first dioptre is comprised within the capture lens, and wherein the second dioptre is comprised within the projection lens and is in the path of the beam reflected by the first dioptre;
the additional image is an image of the scene in a spectral band different to the spectral band of the image captured by the capture lens.

Other characteristics and advantages of the invention will become apparent from a reading of the following description of embodiments of the invention, which are provided solely by way of example, and by reference to the drawings:

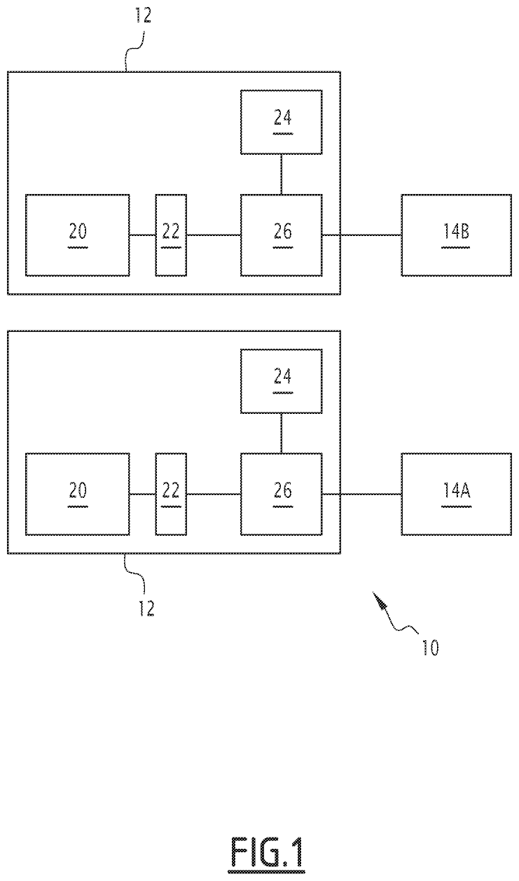

FIG. 1 is a schematic representation of an example of night-vision binoculars according to a first and a second embodiment,

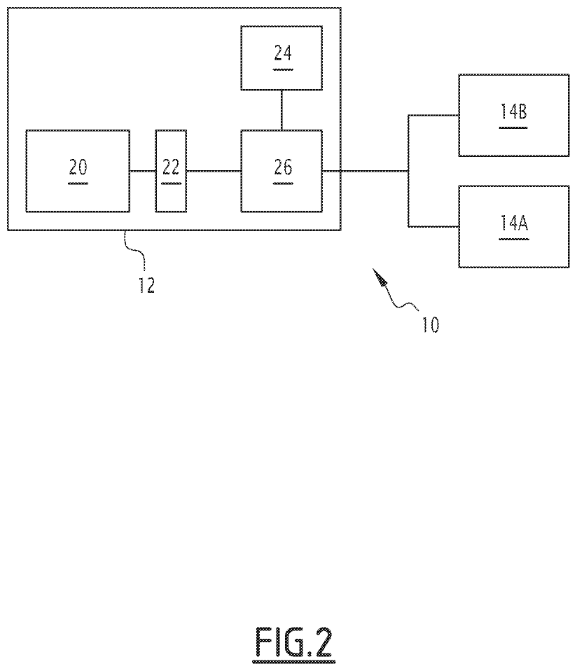

FIG. 2 is a schematic representation of an example of night-vision binoculars according to a third embodiment,

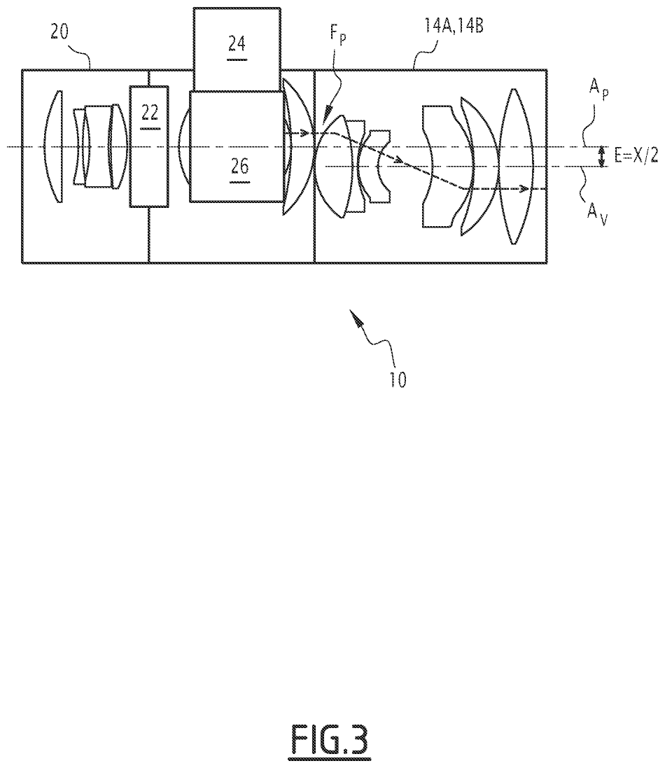

FIG. 3 is a schematic representation of an example of a path of the night-vision binoculars according to the first embodiment,

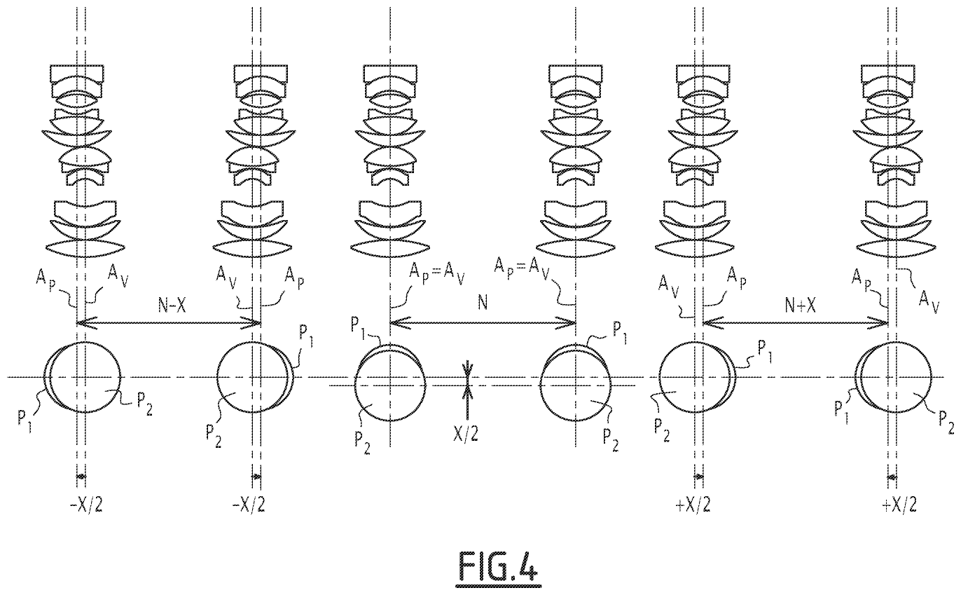

FIG. 4 is a schematic representation of various examples of IPD adjustment according to the first embodiment, showing the offsets between the entrance pupil of the lens assemblies and the exit pupil of the eyepieces,

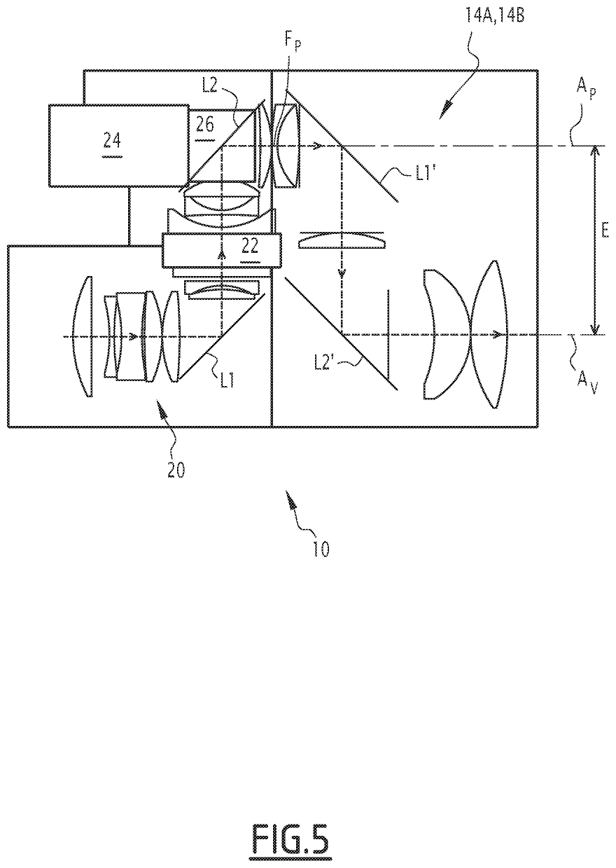

FIG. 5 is a schematic representation of an example of a path of the night-vision binoculars according to the second embodiment,

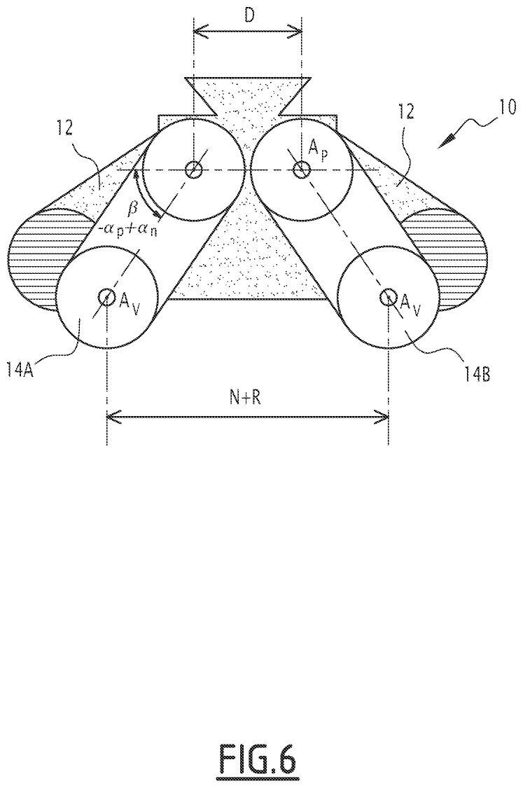

FIG. 6 is a schematic representation of an example of IPD adjustment according to the second embodiment,

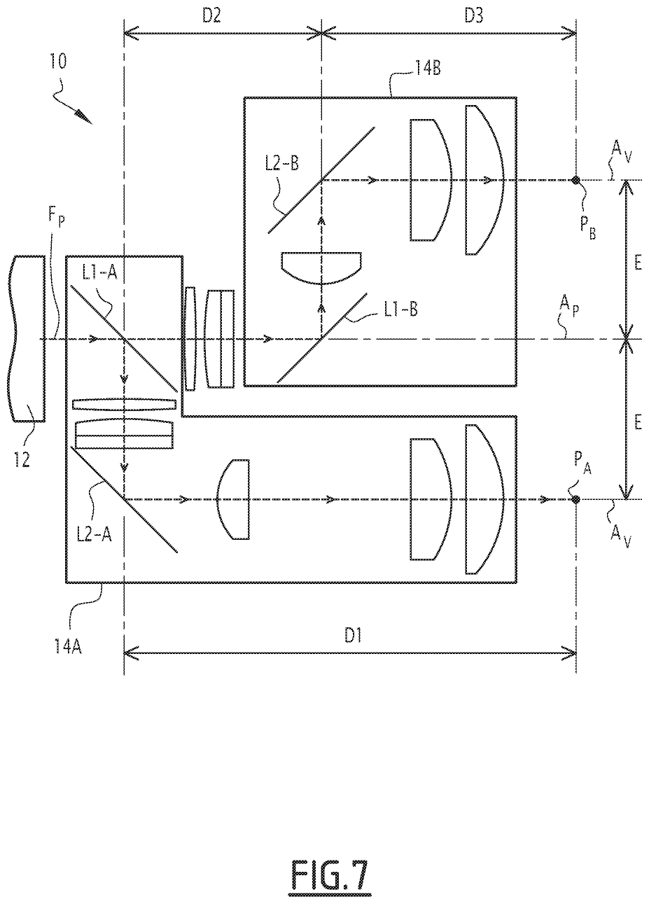

FIG. 7 is a schematic representation of an example of the two paths of the night-vision binoculars according to the third embodiment, and

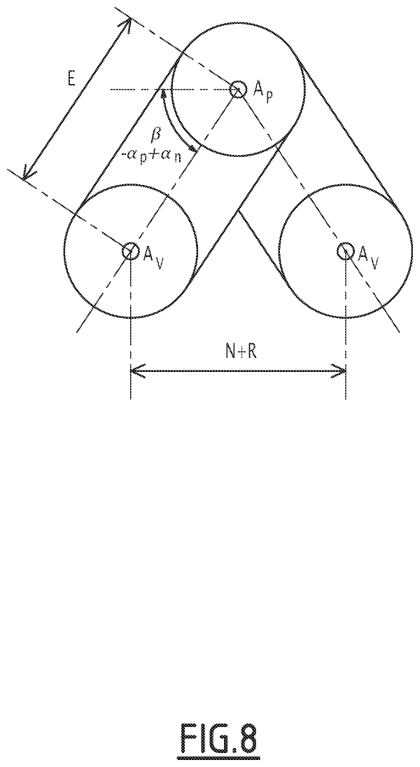

FIG. 8 is a schematic representation of an example of IPD adjustment according to the third embodiment.

Examples of night-vision binoculars 10 are shown schematically in FIGS. 1 and 2. FIG. 1 corresponds to a first and a second embodiment of the invention. FIG. 2 corresponds to a third embodiment of the invention. As described below, the binoculars 10 are ‘connected’ binoculars because they comprise a screen and a projection lens.

This description first describes the elements common to the three embodiments. Each embodiment is thereafter described more specifically.

### GENERIC EMBODIMENT

The binoculars 10 are, e.g., intended to be mounted on a helmet or head harness. Advantageously, the binoculars 10 are also intended to be affixed to a vertically (up-down) adjusted support, thus allowing the height of the binoculars 10 to be adjusted.

As shown in FIGS. 1 and 2, the binoculars 10 comprise at least one lens assembly 12 and two eyepieces 14A, 14B.

When the binoculars 10 comprise two distinct lens assemblies 12, as in FIG. 1, each eyepiece 14A, 14B is associated with a respective lens assembly 12, and thus does not receive beams of light originating from the other lens assembly 12. When the binoculars 10 comprise a single lens assembly 12, as in FIG. 2, the lens assembly 12 is shared by the two eyepieces 14A, 14B.

The association of one eyepiece 14A, 14B with the corresponding lens assembly 12 forms an optical path, with the binoculars 10 thus comprising two optical paths.

Each lens assembly 12 is fixed, i.e. it cannot be translated or rotated.

Each lens assembly 12 comprises at least the following elements: a capture lens 20, a light intensification device 22, a screen 24, and a projection lens 26.

The capture lens 20 is configured to capture an image of a scene. For example, the capture lens 20 comprises an assembly of several lenses.

The light intensification device 22 is configured to intensify the image captured in order to obtain an intensified image. For example, the light intensification device 22 comprises one or more intensifier tubes.

The screen 24 is suited to generate an additional image. The additional image is intended to provide additional information to the user of the binoculars 10.

For example, the additional image is an image of the scene in a spectral band different to the spectral band of the image captured by the capture lens 20. For example, the different spectral band is within an infrared (near, far, or middle infrared) band, whilst the capture lens 20 is, e.g., suited to capture images in the visible band (380-780 nm) or extended (400-900 nm) band. The additional image is, e.g., obtained by an additional optical path present in the binoculars 10.

In one variant, the additional image originates from data obtained by sensors or other sources of information.

The projection lens 26 is configured to project the additional image on the intensified image such that the output beam of the projection lens 26 (‘projection beam FP’) transports the resultant image (superimposition of the intensified image and the additional image). It should be noted that only one ray of the beam FP is shown in the relevant figures for the sake of simplicity.

Advantageously, in the intermediate space between the projection lens 26 and the corresponding eyepiece 14A, 14B, the projection beam FP is a collimated or near collimated beam. ‘Collimated’ means that the rays of the projection beam FP are parallel or nearly parallel in the intermediate space. ‘Near collimated’ means that the rays of the projection beam FP are nearly parallel locally, i.e. over a distance of less than or equal to a value that allows the optical axis of each eyepiece 14A, 14B to be made insensitive to eccentricities of the mechanical axis between the eyepieces 14A, 14B and the one or more corresponding lens assemblies 12.

The projection lens 26 has an output axis (‘projection axis AP’), which is also the output axis of the lens assembly 12.

For example, the projection lens 26 comprises an assembly of several lenses.

Each eyepiece 14A, 14B is an image-transporting lens, i.e. it is suited to transport the image resulting from the projection to the user's eye.

When the binoculars 10 comprise two distinct lens assemblies 12, as shown in FIG. 1, the two eyepieces 14A, 14B receive distinct projection beams FP and thus transport distinct resultant images. When the binoculars 10 comprise a single lens assembly 12, as shown in FIG. 2, the two eyepieces 14A, 14B receive the same projection beam FP and thus transport the same resultant image.

Each eyepiece 14A, 14B has an output axis (vision axis AV′) (see, inter alia, FIG. 3-8, which will be described in detail below). The vision axes of the two eyepieces 14A, 14B are parallel and separated by an adjustable distance (‘inter-pupillary distance IPD’). The IPD is typically the sum of a nominal distance N (fixed) and an adjustment range R (variable).

The vision axis Av of each eyepiece 14A, 14B is parallel to the projection axis AP of the corresponding lens assembly 12 and is a non-zero centre-to-centre distance E from the projection axis A P of the corresponding lens assembly 12. The centre-to-centre distance is the same for both eyepieces 14A, 14B.

Each eyepiece 14A, 14B is rotatable relative to the projection axis AP of the corresponding lens assembly 12 so as to change the adjustment range R and thus adjust the inter-pupillary distance IPD.

The aspects of the operation of the binoculars 10 that are common to the three embodiments will now be described.

To adjust the IPD between the eyepieces 14A, 14B of the binoculars 10, the user turns each of the eyepieces 14A, 14B about the projection axis AP of the corresponding lens assembly 12. In particular, for an average adjustment configuration in which the adjustment range R is nil, the user turns each of the eyepieces 14A, 14B outward in order to increase the IPD and inward in order to decrease the IPD.

Once the IPD has been adjusted, the image resulting from the projection of the additional image over the intensified image of the scene is visible to the user through each of the eyepieces 14A, 14B.

Thus, such connected night-vision binoculars 10 allow the image resulting from the projection of the additional image over the intensified image of the scene to be visualised via both eyepieces 14A, 14B. This makes it easier to visualise such an image than with the known-art devices, in which the resultant image can only be seen on one optical path.

In particular, compared to known-art binoculars that comprise linear IPD adjustment, the adjustment of the IPD via a rotation mechanism makes it easier to incorporate the power cables of the light intensification device 22 and the screen 24 into the binoculars 10. Thus, the cables do not pass through the eyepieces 14, 14B and are independent of the IPD adjustment mechanism.

Moreover, unlike known-art binoculars that comprise rotary IPD adjustment, the IPD adjustment does not affect the resultant image of the scene. This is due to the fact that only the eyepieces 14A, 14B are mobile, whilst the one or more lens assemblies 12 comprising the screen 24 are fixed.

Thus, the connected night-vision binoculars 10 allow the resultant image to be visualised on each of the eyepieces 14A, 14B, whilst maintaining the adjustability of the IPD, by means of a dissymmetry between the projection axis A_{P} of the/each lens assembly 12 and the vision axis Av of the corresponding eyepieces 14A, 14B.

Such an architecture can be adapted both for binocular and binocular binoculars. In particular, it allows for night-vision binoculars with optical fusion (intensified path and infrared path) with a single infrared capture path that is redistributed over the two projection paths (right, left) and compatible with IPD adjustment on both paths.

Moreover, when the beam in the intermediate space is collimated or near collimated, the maintenance of parallelism between the right and left paths is facilitated after the IPD has been adjusted.

### First Embodiment

Below, the specific aspects of the binoculars 10 according to the first embodiment are described by reference to FIGS. 1, 3, and 4.

As noted above, the binoculars 10 according to the first embodiment comprise two lens assemblies 12. Such lens assemblies 12 are advantageously identical. The optical axis of each lens assembly 12 advantageously coincides with the projection axis A_{P} of the projection lens 26 of the lens assembly 12.

In the first embodiment, the vision axis Av of each eyepiece 14A, 14B coincides with the optical axis of the eyepiece 14A, 14B. Thus, the input axis of each eyepiece 14A, 14B coincides with the vision axis AV of that eyepiece 14A, 14B.

In the first embodiment, the adjustment range R has a value within a limited range [−X; +X] centred on zero. The maximum limit +X of the range is thus equal to the opposite of the minimum limit −X of the range. As shown in FIG. 3, the centre-to-centre distance E between the vision axis AV of each eyepiece 14A, 14B and the projection axis AP of the corresponding lens assembly 12 is equal to half +X/2 the positive limit +X of the limited range (maximum limit).

FIG. 4 shows three configurations obtained by rotating each eyepiece 14A, 14B about the corresponding projection axis A_{P} so as to obtain different adjustments of the IPD. In particular, this figure also shows the exit pupils P₁ of the lens assemblies 12 and the exit pupils P₂ of the eyepieces 14A, 14B.

The medium configuration (medium adjustment) corresponds to an average distance for which the IPD is equal to the nominal distance N, where the adjustment range R is nil. In this configuration, the relative eccentricity of the eyepieces 14A, 14B is orientated vertically, and does not contribute to the IPD adjustment. In the configuration shown, the eccentricity is orientated downward. However, upward eccentricity is also possible. When the binoculars 10 are affixed to a vertically (up-down) adjusted support, the vertical eccentricity of the binoculars 10 can be compensated for by translation.

The configuration on the left corresponds to a minimal IPD, for which the adjustment range R is equal to the lower limit −X of the limited range [−X; +X]. In this case, the IPD is equal to N−X. Relative to the medium adjustment (medium configuration), the eccentricity of each eyepiece 14A, 14B relative to the corresponding lens assembly 12 is orientated inward.

The configuration on the right corresponds to a maximum IPD, for which the adjustment range R is equal to the upper limit +X of the limited range [−X; +X]. In this case, the IPD is equal to N+X. Relative to the medium adjustment (medium configuration), the eccentricity of each eyepiece 14A, 14B relative to the corresponding lens assembly 12 is orientated outward.

Thus, the binoculars 10 according to the first embodiment have a dissymmetry obtained by eccentricity between the projection lenses and the corresponding eyepieces 14A, 14B, which allows for the IPD adjustment and the other advantages described in relation to the generic embodiment.

### Second Embodiment

Below, the specific aspects of the binoculars 10 according to the second embodiment are described by reference to FIGS. 1, 5, and 6.

As noted above, the binoculars 10 according to the second embodiment comprise two lens assemblies 12 (one for each eyepiece 14A, 14B). Such lens assemblies 12 are advantageously identical.

In the specific example shown in FIG. 5, the input axis of each lens assembly 12 does not coincide with the projection axis A_{P} of the projection lens 26 of the lens assembly 12.

In particular, in this example, the input axis of each lens assembly 12 is offset from the projection axis A_{P} of the corresponding projection lens 26 by a layover formed by two dioptres L1, L2. In this example, each dioptre L1, L2 has a flat optical surface that is parallel to the flat optical surface of the other dioptre. Such a layover is also referred to as a rhombohedral layover. The first dioptre L1 is comprised in the capture lens 20 and is suited to reflect the captured and intensified image of the scene in the direction of the second dioptre L2. The second dioptre L2 is comprised in the projection lens 26, and is on the path of the beam reflected by the first dioptre L1.

In this example, the flat optical surface of the second dioptre L2 is partially reflective, so as to reflect the beam originating from the first dioptre L1 on the one hand, and, on the other, transmit the beam originating from the screen 24, such that the two beams are superimposed in the direction of the projection axis AP exiting the second dioptre L2. For example, the first dioptre L1 is a reflective mirror.

Persons skilled in the art will understand that the second embodiment is not limited to such a configuration of the lens assemblies 12, and is functional no matter the configuration of the lens assemblies 12. Thus, in one variant, the input axis of each lens assembly 12 coincides with the projection axis A_{P} of the projection lens 26 of the lens assembly 12, as is the case in the first embodiment.

In the second embodiment, as shown in FIG. 5, each eyepiece 14A, 14B has an input axis that coincides with the projection axis AP of the corresponding lens assembly 12. The vision axis AV (output axis) of each eyepiece 14A, 14B is offset from the input axis of the eyepiece 14A, 14B by a layover formed by two dioptres L2′. In this example, each dioptre L1′, L2′ has a flat optical surface that is parallel to the flat optical surface of the other dioptre. Such a layover is also referred to as a rhombohedral layover. The input axis of the rhombohedron (and thus, of the eyepiece) is centred on the projection axis A_{P} of the corresponding projection lens 26.

In particular, the first dioptre L1′ is positioned so as to be in the path of the projection beam F_{P} as it exits the corresponding projection lens 26 and to reflect the projection beam F_{P} in the direction of the second dioptre L2′. The second dioptre L2′ is positioned so as to reflect the projection beam FP in the direction of the vision axis Av. In one example, the first dioptre L1′ and the second dioptre L2′ are reflective mirrors.

In this second embodiment, the adjustment range R is a function of: The centre-to-centre distance E between the projection axis A_{P} and the vision axis AV of the corresponding eyepiece 14A, 14B, a nominal orientation β of the eyepieces 14A, 14B, and a rotation angle αp, αn of each eyepiece 14A, 14B relative to the nominal orientation β. The nominal orientation β is defined as the angle between the plane comprising the two projection axes A_{P} (right and left) and the symmetry axis of the rhombohedron.

More precisely, for example, the nominal distance N is given by the following formula:

N=D+2·E·tan(β)

Where:
D is the centre-to-centre distance between the projection axes of the two lens assemblies 12 (shown in FIG. 6).

The adjustment range R is, e.g., given by the following formula:

$$R = \{ \begin{matrix}2 \cdot E \cdot tan ( β - {α}_{p} ) when the lenses 14 A , 14 B rotate outward , or \\ - 2 \cdot E \cdot tan ( β + {α}_{n} ) when the lenses 14 A , 14 B rotate inward .\end{matrix}$$

Where:
αₚ is the rotation angle of each eyepiece 14A, 14B relative to the nominal orientation β when moved apart, and
αₙ is the rotation angle of each eyepiece 14A, 14B relative to the nominal orientation β when brought closer together.

Thus, the IPD is adjusted by rotating each of the eyepieces 14A, 14B about the corresponding projection axis A_{P}.

In particular, in the medium adjustment position, the relative rotation of the plane of symmetry of the rhombohedra of the eyepieces 14A, 14B relative to the lens assemblies 12 is orientated on the nominal orientation β (αₚ and αₙ are nil). At maximum distance, this rotation is orientated outward by the angle β−αₚ. At minimum distance, this rotation is orientated inward by the angle β+αₙ.

Thus, the binoculars 10 according to the second embodiment have a dissymmetry obtained by a rhombohedral layover of the eyepieces 14A, 14B, which allows for the IPD adjustment and the other advantages described in relation to the generic embodiment.

The range of rotation of the eyepieces 14A, 14B for the IPD adjustment is reduced compared to the first embodiment. Moreover, aberrations are reduced because the overall optical system has rotational symmetry.

Moreover, in the second embodiment, the length of the binocular bodies 10 is reduced compared to conventional binocular inline optics. As such, the cantilever of the binoculars 10 mounted on a helmet or head harness is reduced.

### Third Embodiment

Below, the specific aspects of the binoculars 10 according to the third embodiment are described by reference to FIGS. 2, 7, and 8.

As noted above, the binoculars 10 according to the third embodiment comprise a single lens assembly 12 shared by both eyepieces 14A, 14B. In particular, the projection axis A_{P} is the shared rotation axis of the two eyepieces 14A, 14B. For example, the lens assembly 12 is a lens assembly according to any of the examples described for the first or third embodiment.

In the third embodiment, as shown in FIG. 7, each eyepiece 14A, 14B has an input axis that coincides with the projection axis A_{P} of the same lens assembly 12. The vision axis A_{V} (output axis) of each eyepiece 14A, 14B is offset from the input axis of the eyepiece 14A, 14B by a layover formed by two dioptres: L1-A, L2-A for the eyepiece 14A and L1-B, L2-B for the eyepiece 14B. Each of the dioptres L1-A, L2-A has a flat optical surface that is parallel to the flat optical surface of the other dioptre L1-A, L2-A. Each of the dioptres L1-B, L2-B has a flat optical surface that is parallel to the flat optical surface of the other dioptre L1-B, L2-B. As with the third embodiment, such layovers are rhombohedral. The input axis of each rhombohedron is centred on the projection axis A_{P} of the projection lens 26.

In particular, the flat optical surface of the first dioptre L1-A of the first eyepiece 14A is partially reflective. The first dioptre L1-A of the first eyepiece 14A is positioned so as to be in the path of the projection beam F_{P} exiting the projection lens 26 so as to reflect part of the projection beam F_{P} in the direction of the second dioptre L2-A of the first eyepiece 14A and to transmit the other part in the direction of the first dioptre L1-B of the second eyepiece 14B.

The second dioptre L2-A of the first eyepiece 14A is positioned so as to reflect the projection beam F_{P} originating from the first dioptre L1-A in the direction of the vision axis A_{V} of the first eyepiece 14A. For example, the second dioptre L2-A is a reflective mirror.

The first dioptre L1-B of the second eyepiece 14B is positioned so as to receive and reflect the part of the beam transmitted by the first dioptre L1-A of the first eyepiece 14A in the direction of the second dioptre L2-B of the second eyepiece 14B. For example, the first dioptre L1-A is a reflective mirror.

Le second dioptre L2-B of the second eyepiece 14B is positioned so as to reflect the projection beam FP originating from the first dioptre L1-B of the second eyepiece 14B in the direction of the vision axis A_{V} of the second eyepiece 14B. For example, the first dioptre L1-B is a reflective mirror.

Advantageously, the centre-to-centre distance E between the projection axis AP and the vision axis AV of each eyepiece 14A, 14B (which also corresponds to the distance between the reflective surfaces de each rhombohedron) meets the following condition:

E+D1=D2+E+D3

Where:
D1 is the distance, along the vision axis A_{V} of the first eyepiece 14A, between the first dioptre L1-A and the focal point PA of the first eyepiece 14A,
D2 is the distance, along the projection axis A_{P}, between the first dioptre L1-A of the first eyepiece 14A and the first dioptre L1-B of the second eyepiece 14B, and
D3 is the distance, along the vision axis A_{V} of the second eyepiece 14B, between the second dioptre L1-B and the focal point P B of the second eyepiece 14B.

In this third embodiment, the adjustment range R is a function of: The centre-to-centre distance E between the projection axis A_{P} and the vision axis A_{V} of the corresponding eyepiece 14A, 14B, a nominal orientation β of the eyepieces 14A, 14B, and a rotation angle αp, an of each eyepiece 14A, 14B relative to the nominal orientation β.

More precisely, for example, the nominal distance N is given by the following formula:

N=2·E·tan(β)

The adjustment range R is, e.g., given by the following formula:

$$R = \{ \begin{matrix}2 \cdot E \cdot tan ( β - {α}_{p} ) when the lenses 14 A , 14 B rotate outward , or \\ - 2 \cdot E \cdot tan ( β + {α}_{n} ) when the lenses 14 A , 14 B rotate inward .\end{matrix}$$

Where:
αₚ is the rotation angle of each eyepiece 14A, 14B relative to the nominal orientation β when moved apart, and
αₙ is the rotation angle of each eyepiece 14A, 14B relative to the nominal orientation β when moved closer together.

Thus, the IPD is adjusted by rotating each of the eyepieces 14A, 14B about the corresponding projection axis AP.

In particular, in the medium adjustment position, the relative rotation of the plane of symmetry of the rhombohedra of the eyepieces 14A, 14B relative to the lens assemblies 12 is orientated on the nominal orientation β (αp and an are nil). At maximum distance, this rotation is orientated outward by the angle β−αp. At minimum distance, this rotation is orientated inward by the angle β+αₙ.

Thus, the binoculars 10 according to the third embodiment allow for a binocular vision device having dissymmetry with each eyepiece 14A, 14B, produced by a rhombohedral layover of the eyepieces 14A, 14B. This allows for IPD adjustment and the other advantages described in relation to the generic embodiment.

The range of rotation of the eyepieces 14A, 14B for the IPD adjustment is reduced compared to the first embodiment. Moreover, aberrations are reduced because the overall optical system has rotational symmetry.

Moreover, in the third embodiment, the length of the binocular bodies 10 is reduced compared to conventional biocular inline optics. As such, the cantilever of the binoculars 10 mounted on a helmet or head harness is reduced.

Persons skilled in the art will understand that the embodiments described above can be combined where compatible. In particular, the rhombohedral lens assembly 12 described in relation to the second embodiment is compatible with the first and third embodiment. Likewise, the inline lens assembly 12 described in relation to the first embodiment is compatible with the second and third embodiment.

Moreover, persons skilled in the art will understand that, for an optical system, the term ‘output axis’ corresponds to the optical axis of the optic at the output of the optical system, and that the term ‘input axis’ corresponds to the optical axis of the optic at the input of the optical system. Thus, where the optical system is centred, the output axis and the input axis both correspond to the optical axis of the optical system. In particular, in the embodiments described, the projection axis A_{P} (output axis of the lens assembly) is parallel to the input axis of the lens assembly (optical axis of the capture lens 20).

Lastly, persons skilled in the art will understand that, in the second and third embodiment (FIGS. 5 and 6, on the one hand, and FIGS. 7 and 8, on the other), the nominal orientation refers to an orientation taken as a reference. In particular, in the second embodiment (FIGS. 5 and 6), the nominal orientation is the angle β between the plane comprising the two projection axes and the symmetry axis of the rhombohedron. The symmetry axis of the rhombohedron corresponds to the plane of symmetry of the rhombohedron, with this plane being the one containing the output axis of the projection lens and the output axis of the corresponding eyepiece. In the third embodiment (FIGS. 7 and 8), because there is only a single projection axis, it is also possible to define the nominal orientation as the angle between the plane comprising the two output axes of the eyepieces (IPD adjustment in nominal position) and the axis of symmetry of the rhombohedron.

1. Night-vision binoculars, comprising:
a. one or two fixed lens assemblies, the or each lens assembly comprising:
i. a capture lens configured to capture an image of a scene,
ii. a light intensification device configured to intensify the image captured in order to obtain an intensified image,
iii. a screen suited to generate an additional image,
iv. a projection lens configured to project the additional image on the intensified image such that the output beam of the projection lens, called projection beam, transports the resultant image, wherein the projection lens has an output axis, called projection axis,
b. two eyepieces that receive either the same projection beam, when the binoculars comprise a single lens assembly, or different projection beams, when the binoculars comprise two lens assemblies,
wherein each eyepiece has an output axis, called vision axis, the vision axes of the two eyepieces being parallel and separated by an adjustable distance, called inter-pupillary distance,
wherein the vision axis of each eyepiece is further parallel to the projection axis of the corresponding lens assembly and has the same non-zero centre-to-centre distance as the projection axis of the corresponding lens assembly,
wherein each eyepiece is rotatable relative to the projection axis of the corresponding lens assembly so as to adjust the inter-pupillary distance.

2. Night-vision binoculars according to claim 1, wherein the projection beam is a collimated or near collimated beam.

3. Night-vision binoculars according to claim 1, wherein the vision axis of each eyepiece is the optical axis of the eyepiece.

4. Night-vision binoculars according to claim 1, wherein the binoculars comprise two lens assemblies, the inter-pupillary distance being the sum of a nominal distance and an adjustment range, the value of the adjustment range being a function of the rotation of each eyepiece and being within a limited range centred on zero, the centre-to-centre distance between the vision axis of each eyepiece and the projection axis of the corresponding lens assembly being equal to one-half of the positive limit of the limited range.

5. Night-vision binoculars according to claim 1, wherein each eyepiece has an input axis that coincides with the projection axis of the corresponding lens assembly, wherein the vision axis of each eyepiece is offset from the input axis of the eyepiece by a layover formed by two dioptres, each dioptre having a flat optical surface parallel to the flat optical surface of the other dioptre, wherein the first dioptre is configured to reflect at least part of the projection beam output by the corresponding lens assembly in the direction of the second dioptre, wherein the second dioptre is configured to reflect the projection beam in the direction of the vision axis.

6. Night-vision binoculars according to claim 1, wherein the inter-pupillary distance is the sum of a nominal distance and an adjustment range that is a function of the rotation of each eyepiece, wherein the adjustment range is a function of the centre-to-centre distance between the projection axis and the vision axis of the eyepieces, a nominal orientation of the eyepieces, and a rotation angle of each eyepiece relative to the nominal orientation.

7. Night-vision binoculars according to claim 1, wherein the binoculars comprise two lens assemblies.

8. Night-vision binoculars according to claim 5, wherein the binoculars comprise a single lens assembly, such that the projection axis is the common rotation axis of the two eyepieces, wherein the flat optical surface of the first dioptre of one of the eyepieces, called first eyepiece, is partially reflective, so as to reflect part of the projection beam in the direction of the second dioptre of the first eyepiece and to transmit the other part in the direction of the other eyepiece, called second eyepiece.

9. Night-vision binoculars according to any of claim 1, wherein the or each lens assembly comprises an input axis that is offset from the projection axis of the corresponding projection by a layover formed by two dioptres, wherein each dioptre has a flat optical surface parallel to the flat optical surface of the other dioptre, wherein the first dioptre is comprised within the capture lens, and wherein the second dioptre is comprised within the projection lens and is in the path of the beam reflected by the first dioptre.

10. Night-vision binoculars according to claim 1, wherein the additional image is an image of the scene in a spectral band different to the spectral band of the image captured by the capture lens.
